(19) United States
(12) Patent Application Publication
(10) Pub. No.: US 2005/0261399 A1
(43) Pub. Date: Nov. 24, 2005

(54) Powdered flocculants prepared by using evaporative cooling to coat polymeric materials on a porous substrate

(76) Inventor: David Hunkeler, Loisin (FR)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/848,652

(22) Filed: May 19, 2004

(51) Int. Cl. C08K 5/15; C08K 3/34

(52) U.S. Cl. 524/56; 524/445

(57) ABSTRACT

The invention is a polymeric powder that is useful as a flocculant and an associated process for preparing the same. The powder is prepared from spraying a liquid containing a water-soluble polymer into a fluidized bed of porous substrate particles. The spraying process coats the polymer onto the substate and removes the water through evaporative cooling. Polymeric powders prepared according to the invention rapidly dissolve in water and have improved viscosities over thermally dried polymer powders. Polymers that are useful in the invention include polyacrylamides, polyamines, and the like. The substrate is a porous material that can be either organic or inorganic, and typically has a porosity from about 1 to 1,000 m²/g.

### FIELD OF THE INVENTION

The invention relates generally to powder flocculants that are used to treat effluent wastewater, and in particular to powder flocculants that are prepared from spraying a polymer-containing liquid over a bed of fluidized substrate particles.

### BACKGROUND OF THE INVENTION

Water-soluble and water-swellable synthetic polymeric materials such as polyacrylamides have long been used as flocculants in wastewater treatment and other processes in which it is desirable to remove suspended solid materials. These polymers have found use in numerous applications such as water treating, oil recovery, paper manufacturing, mining, agriculture, and the like.

Water-soluble polymers are often commercially synthesized through heterophase water-in-oil polymerization processes. Typically, these processes permit polymerizations at higher solid concentrations, low viscosities, and with better temperature control. Two categories of heterophase polymerization include inverse macroemulsion and inverse microemulsion polymerization. Inverse emulsion polymerization produces a water-in-oil emulsion that contains the water-soluble polymer in the aqueous phase.

The majority of acrylamide-based polymers are produced commercially using inverse macroemulsion polymerizations. A typical commercial recipe includes a continuous aliphatic or aromatic organic phase, a mixture of emulsifiers to achieve an HLB between 4 and 6, monomer(s), water, chemical initiator(s), and additives. Monomer(s) typically include acrylamide, anionic species includingacrylic and methacrylic acids, and quaternary ammonium cations. Methods of preparing inverse emulsions are described in U.S. Pat. No. 3,284,393.

Water-in-oil polymeric macroemulsions and microemulsion are typically converted into either an aqueous solution or a dry powder after polymerization. It may be more desirable to produce the polymer in powder form because of transportation costs that are associated with transporting an emulsion, and stability problems that can also be associated with an emulsion.

Inverse emulsions can be azeotropically dried, as disclosed in U.S. Pat. No. 4,628,072 and U.S. Pat. No. 4,506,062. Azeotropic distillation tends to be energy-intensive, and the filtering process may be hazardous and/or inefficient.

The most common techniques for preparing a dry polymer powder from an emulsion or dispersion are based on spraying. In general, spraying requires that the oil phase be removed from the emulsion followed by evaporation of the water. U.S. Pat. No. 4,035,317 describes a process for preparing a dry polymer wherein a water-in- oil emulsion is sprayed from a nozzle into a gas stream that is at a temperature of at least 212° F. U.S. Pat. No. 6,011,089 describes a process for preparing a dry water-soluble polymer particle by spraying a polymer-containing dispersion, water-in-oil emulsion, or water-in-oil microemulsion into a gas stream that is at a temperature from 70 to 100° C. The oil phase is separated and recovered after removal.

In general, current spray drying techniques have produced dry polymeric polymers that have been useful in commercial applications. However, spray drying techniques still have some significant disadvantages. For example, during spray drying the oil phase is typically removed. As a result, it may be necessary to have additional equipment for recovering and recycling the oil phase. Such methods typically require washing the oil phase with an aqueous acid to remove unwanted substances, and to reduce any formaldehyde that may be present to below 0.1 percent.

Additionally, as described above, spray drying typically involves evaporating the water using thermal energy, such as a stream of heated gas. Thermal drying can result in changing the dried polymer's physical properties such as a reduction in the polymer's viscosity. Thermal drying can also result in crosslinking or degradation of the polymer. Such degradation or crosslinking could cause the polymeric flocculant to function improperly in water treatment applications. Highly charged or highly branched polymers also tend to gel rather than dry when heated.

Thus, there still exists a need to develop powdered polymeric materials that are efficiently dried without adversely affecting or degrading the polymer.

### BRIEF SUMMARY OF THE INVENTION

The invention is a polymeric powder and associated process for preparing a dry free-flowing powder that does not require thermal drying to form the powder. As a result, the process produces a flocculant powder having advantageous properties and does not require equipment for removing and recycling the oil phase.

Flocculant powders prepared in accordance with the invention are typically prepared from high molecular weight water-soluble polymers that are coated onto a porous substrate material. The process uses evaporative cooling to remove the water phase from the flocculant material and to coat the polymeric material onto the substrate.

To prepare the powders, a bed of substrate material is fluidized and is contacted with a mist of liquid containing the polymeric material. The polymeric material penetrates and coats the porous substrate, while at the same time the water phase is removed via evaporative cooling.

The liquid containing the substrate is typically a heterophase emulsion, such as an inverse macroemulsion or suspension. The polymeric material can be chosen from a variety of different polymers that are water-soluble or water-swellable. The polymer can typically be polymerized in the liquid. Typically, the polymers have polyelectrolyte monomers that can be either cationic or anionic in nature. Useful polymers include polyacrylamides, polyamides, and the like. Alternatively, a dry polymeric material can be used to coat the substrate.

The substrate is typically a porous material that can be organic or inorganic. Suitable substrates include polysaccharides and their functional equivalents including sugars, glucose, maltos, manitol, kaolin, zeolites, calc, coagulants such as ferric chloride, ferric sulfate, aluminium sulphate, and mixtures thereof. The porous substrate material typically has an internal surface area from about 1 to 1,000 m²/g. Somewhat more typical is an internal surface area from about 1 to 100 m²/g or 10 to 100 m²/g.

Typically, each substrate particle can be coated with an amount of polymeric material that is from about 100 to 1000 percent of the initial mass of the substrate particle. The powders typically have a polymeric solid content that is from about 15 to 57 weight percent based on the total weight of the powder. Somewhat more typically, the powders have a polymeric content that exceeds 20 weight percent. The most typical range is a polymeric content that is from about 30 to 47 weight percent.

Polymeric powders prepared in accordance with the invention typically dissolve quickly in water, typically in less than 15 minutes and to within 1 percent of the polymer's final viscosity. The spraying process can be carried out at or near room temperature. As a result, there is no degradation or crosslinking of the polymeric material. Typically, the evaporative cooling process does not affect, or minimally affects the final product's viscosity.

Thus, the invention provides, among other things, improved polymeric powders that are particularly useful as flocculants. The invention also includes an associated method for producing the powders in the absence of thermal drying, and that does not adversely affect the powders prepared therefrom.

### DETAILED DESCRIPTION OF THE INVENTION

The invention now will be described more fully hereinafter, may be embodied in many different forms, and should not be construed as limited to the embodiments set forth herein; rather, these embodiments are provided so that this disclosure will satisfy applicable legal requirements.

Flocculant powders in accordance with the invention are formed from coated particulates that are comprised of water-soluble polymers that are coated onto a porous substrate (also referred to as the “incipient”). A bed of the substrate material is fluidized to make the flocculant powder. Fluidization refers to a technique in which a finely divided solid is caused to behave like a fluid by suspending it in a moving gas or liquid.

After the substrate particles have been fluidized, an excipient material, typically a liquid, comprising a water-soluble polymer is sprayed into the bed. Preferably the polymeric liquid contacts the substrate as a mist that can be a fine or atomized mist. During the spraying process, the organic phase is generally trapped and substantially absorbed into the porous substrate, and the polymeric material is coated onto the substrate as the water phase undergoes evaporative cooling and leaves the system. The final polymer product, although being essentially wet in nature, is a dry to the touch, free-flowing polymer powder. The viscosity of the final polymer product is not changed or significantly affected by the drying process. The method is also useful for preparing polymeric powders from branched polymers and polymers that are comprised 80 percent or greater cationic polyelectrolyte monomers.

A liquid containing the polymer is sprayed into the fluidized bed of substrate particles to produce the polymeric powders that are in accordance with the invention. Suitable liquids for this process typically include, without limitation, heterophase systems such as inverse macroemulsion, inverse microemulsions, inverse suspensions, emulsions/dispersions, aqueous solutions, and solutions and dispersions that are in volatile polar liquids. Typically, the polymeric liquid should be a pumpable liquid having a viscosity that is from about 0.01 to 10,000 cp. Preferably the viscosity is from about 1 to 1,000 cp, and more preferably, the liquid has a viscosity that is from about 10 to 100 cp. Typically, the polymeric concentration in the liquid can be from about 0.1 to 99 percent by weight. Polymeric concentrations from about 5 to 50 percent or 10 to 40 percent by weight are somewhat more typical.

Alternatively, the excipient can be a dry polymeric material. In this case, a dry polymer excipient can be added to a fluidized bed containing a porous incipient. Typically, the excipient polymer can be added with a binding agent to aid in binding the polymer to the substrate. Useful binding agents include, but are not limited to cellulose ethers such as HPMC-hydroxy propyl methyl cellulose, HPC-hydroxy propyl cellulose, or MC-methyl cellulose, povidones such as polyvinylpyrollidone (PVP), copovidones such as polyvinylpyrolidone-co-vinylacetate, starch derivatives such as hydrolyzed maize starge, or pregelatinized maize starch, polygycolized glycerides such as polyethylene glycol, way, or sucrose esters, and lipids.

Polymeric materials that are useful in the invention are typically high molecular weight water-soluble polymers that are useful for water treatment. Typically, the molecular weight of the polymer can be from about 1,000 to 30 million Daltons. Polymers having molecular weights from about 10,000 to 20 million Daltons, and from about 20,000 to 10 million Daltons are somewhat more typical.

Polymers that are useful include, without limitation, polyacrylamide, polyamines, polydiallyldimethylammonium chloride (polyDADMACS), polyquaternaryamines, and copolymers and derivatives thereof. The liquid could be a solution or water-in-oil heterophase containg a polyelectrolyte polymer that can be either anionic or cationic, and can be based on acrylamides, co- or ter-polymerized with anionic, cationic, or non-ionic monomers.

The monomers used for the preparation of the polymeric material of this invention generally include at least one unsaturated alkyl unit, such as one or more monoethylenically unsaturated monomers. The monomers can be alkenes or alkadienes, including olefinic monomers and vinyl monomers. As used herein, the term “olefin” refers to a class of unsaturated aliphatic hydrocarbons having one or more double bonds, generally obtained by cracking petroleum fractions at high temperatures. Exemplary olefinic monomers include ethylene, propylene, isobutylene, 1-butene, and 1-pentene. As used herein, the term “vinyl” monomers refers to compounds including the vinyl grouping (CH₂═CH—). Exemplary vinyl monomers include vinyl acetate, acrylates, styrene and the like. The ethylenically unsaturated monomers employed in this invention may further be classified in terms of their ionic character, i.e., as non-ionic, cationic, or non-ionic.

Examples of non-ionic monomers include, but are not limited to, acrylamide, methacrylamide, N-vinylmethylacetamide, N-vinyl methyl formamide, vinyl acetate, vinyl pyrrolidone, methyl methacrylate, methacrylic esters, other acrylic or ethylenically unsaturated esters, styrene, and acrylonitrile. Further exemplary non-ionic monomers include dialkylaminoalkymethacrylamide and sulphomethylated acrylamide.

Examples of cationic monomers are dialkylaminoalkylacrylates and methacrylates, especially dialkylamino ethyl acrylate, and their quaternary or acid salts, and dialkylaminoalkylacrylamides or methacrylamides and their quaternary or acid salts and Mannich products, such as quatemized dialkylaminoethylacrylamides. Alkyl groups are generally C₁₋₄ hydrocarbons that may be either branched straight chain. Quaternary salts include quaternary ammonium salts, such as methylated quaternary ammonium salts. For example, the cationic monomers include dimethyl aminoethyl acrylate methyl chloride.

Examples of anionic monomers include, e.g., acrylic acid, sodium acrylate, sodium methacrylate, ammonium acrylate, ammonium methacrylate, methacrylic acid, itaconic acid, 2-acrylamide 2-methyl propane sulphonate, sulphopropylacrylate or methacrylate or other forms of these carboxylic or sulphonic acids, and salts thereof.

The substrate is typically a porous particle that can be selected from a variety of different materials. Possible substrates include both organic and inorganic materials. Suitable organic substrates include, without limitation, polysaccharides and their substitutes such as sugars, glucose, maltos, manitol, and the like. Suitable inorganic materials include, without limitation, kaolin, zeolites, calc, coagulants such as ferric chloride, ferric sulfate, aluminium sulphate (alum), and the like. Additionally, an inorganic substrate can be chosen to produce a hybrid water treatment that has both inorganic coagulant and organic flocculant properties.

The polymeric liquid can also contain additional additives such as chain branching agents, surfactant, stabilizers, dispersants, emulsifiers, cross linking agents, and other known additives. Surfactants and/or dispersing agents are generally helpful and sometimes necessary for the formation and continued stabilization of the polymeric liquid.

Typically, suitable substrates will have internal surface areas that are from about 10 to 1,000 m²/g and/or 10 to 100 m²/g. Substrates having internal surface areas from about 1 to 1,000 m²/g are also useful in the practice of the invention. Substrates having internal surface areas outside these ranges can also be used, although not necessarily with equivalent results. Substrates that are useful in the invention typically have an average particle size from about 1 μm to 30 mm, with particles size from about 3 to 500 μm being particularly useful.

Generally, in fluidized bed spraying, both batchwise and continuously, a series of variables should be optimized to produce a non-agglomerated, non-adhesive (to internal surfaces), free flowing powder with a relatively monodisperse size distribution. A monodisperse size distribution generally means that the particles are generally about the same size. It should be recognized that the particle sizes could have some variances, typically less than 100 percent. Preferably, the size variance is less than 30 percent, with a variance of less than 10 percent being preferred. Such variables include, without limitation, nozzle type and position; air or drying gas flowrate; temperature of the inlet gas, outlet gas, and product; pressure drop on the product and filter; spraying conditions such as atomizer pressure, liquid flowrate, and spraying rate (mass/unit time); viscosity and concentration of the injected polymeric liquid; selection of the substrate's size and internal surface area; and the polymeric liquid's chemistry.

In general, the variables under which the polymeric liquid is sprayed into the fluidized bed is controlled by the thermodynamics of evaporating cooling, which can vary depending upon the particular substrate and polymeric liquid used, and also the above described variables. These variables are exemplified below.

The equipment that is selected for the powderization process should be chosen so that good temperature control is maintained and that there is sufficient mixing to ensure adequate contact between the substrate and polymeric liquid. Optionally, the system could include rotary drum drying or tumble drying mechanisms.

Typically, the substrate is added at a dose rate from about 200 to 700 percent, based on the initial mass of the substrate, per hour. Typically, the amount of polymeric powder that is coated onto the substrate is at levels in excess of 300 percent of the initial mass of the substrate. The particle size and density of the final powdered polymeric product can vary widely depending upon fluidization conditions.

The final product typically has a polymeric solid content from about 15 to 57 weight percent based on the total weight of the powder. Typically, the weight percent of the polymer is in excess 20 weight percent, and up to about 57 weight percent. A more typical amount of polymeric material is from about 30 to 47 weight percent based on the total weight of the powder. The polymer content is roughly equivalent to the amount of active material that is typically present in the original starting liquid. Accordingly, it should be evident that powders that are prepared in accordance with the invention have a polymer concentration that is not significantly different than the starting material. Higher polymer content may be possible if polymers having lower molar masses are used to coat the substrate. In such cases, it may be possible to achieve a powdered product having a polymeric content that is in excess of 90 percent by weight.

The invention can also be used to prepare polymeric powders wherein the polymer is comprised of monomers that have cationic charges that are in excess of 80 and up to 100 percent cationic monomers. Additionally, the invention can be used to form branched polymeric powders.

Polymeric powders prepared in accordance with the invention can be used in a variety of different applications, such as flocculants for waste water treatment, solid/liquid separations, oil recovery, in paper making, biotechnological applications, and food processing. The powders can be used for treating biologically treated suspensions, such as sewage or other municipal and industrial sludges.

The polymer material of this invention is particularly useful for flocculating an aqueous suspension of suspended solids. The polymer can be used in wastewater treatment, e.g., municipal, farm, and industrial waste water. In addition, the polymer can also be used in industrial manufacturing, e.g., treating liquid suspensions to remove solids for purposes of e.g., modifying the color, taste, or viscosity of the aqueous suspension. Conventional flocculating methods known in the art can be used for this purpose. Typically, a flocculating process may include the steps of adding to the suspension a flocculating amount of a polymeric flocculant material according to this invention to form an aqueous medium containing flocculated suspended solids. The flocculating amount, i.e., the effective dosage, of the polymeric flocculant material of this invention may range from about 1 to about 105 ppm, preferably from 4 to about 104 ppm, more preferably from about 5 to about 1000 ppm, and most preferably from about 10 to about 600 ppm. The effective dosage for a powdered product that is comprised of a low molar mass polymer could be as high as 5 to 10 percent.

In an alternative embodiment, one or more water soluble, high cationic charge, low intrinsic viscosity coagulant polymers may also be added to the suspension in addition to the flocculent. Mixtures of coagulants and flocculants are discussed in U.S. Pat. No. 6,001,920. The coagulant polymer can be a polyamine based coagulant polymer, such as formed by the condensation of an amine and/or diamine or higher amine with an epihalohydrin or dihalo alkane. Exemplary coagulants can include a monoethylenically unsaturated monomer, such as a coagulant formed by the condensation of epichlorohydrin with dimethylamine and a small amount of ethylene diamine.

The polymeric powders of the present invention are also useful as a retention agent, in paper manufacturing. They can be added to the paper finish at the wet end of the paper machine in typical amounts such as about 0.05 to about 7 kilograms of active material per ton of finished paper.

As will be apparent to a skilled artisan, the effective dosage of the polymer composition for flocculating a liquid suspension can vary with the concentration of the solids contained in the liquid suspension to be treated, the chemical and physical structure of the polymer flocculant, and the like. Typically, more polymer is needed when the liquid suspension has a higher concentration of solids, and vice versa. Some minor degree of experimentation may be required to determine the optimal dosage of a particular polymer of this invention for a particular liquid suspension to be treated, this being well within the capability of one skilled in the art once apprised of the present disclosure. In any event, the flocculating amount, i.e., the effective dosage typically falls within the ranges as described above.

Once an aqueous medium containing flocculated suspended solids is formed, it is dewatered by a conventional dewatering means, e.g., centrifuge, piston press, or belt press dewatering, or simply allowing the solids to precipitate or settle.

The polymeric powders of the present invention are particularly useful in a dewatering process involving belt filter presses and centrifuges. The performance in such equipment can be manifested by increased solids contents in the filter cake and a reduction in turbidity in the filtrate (belt filter presses) and centrate (centrifuges).

It has, however, been found that there is a close correlation between flocculant performance in real applications and several laboratory tests such as capillary suction time (CST) and the conventional Buchner Funnel method. CST is measured as described in the Journal of Institute of Water Pollution Control, 67:233 (1968). This method involves the addition of a measured dose of flocculent solution to the sludge to be dewatered and applying a defined amount of shear for a measured time. Then, the conditioned sludge sample to be tested is placed in a stainless steel cylinder. The suction pressure of a filter paper beneath the sample cylinder draws out filtrate. The filtrate progresses advances radially in an elliptical pattern. The timer starts when the liquid reaches two electrodes and ceases when the liquid front reaches a third electrode. The best flocculants have the lowest CST values. The conventional Buchner Funnel is used to test the relative effectiveness of various flocculants to dewater a sludge. The test consists of obtaining a representative sludge sample, dividing it into aliquots, adding the desired amount of the polymer being tested, mixing the sludge with the polymer for 10 seconds at 400 rpm, pouring the conditioned sludge into the Buchner funnel with moist filter paper and then determining the drainage time to get a given volume or the filtrate volume after a given time. The best flocculants give the lowest times for a fixed volume or the highest volumes for a fixed time.

### EXAMPLES

The following examples are provided for the purpose of illustration and should not be considered as limiting the invention in any way. In the following examples AlpineFloc™ BHMW refers to a specific polyacrylamide inverse emulsion available from Aqua+Tech, which is located in Geneva, Switzerland. Glacier BHMW refers to the polymeric powder prepared in accordance with the invention from AlpineFloc™ BHMW starting material.

### Example 1

### Free Flowing Dry Powder from a Flocculant Sprayed onto a Porous Inorganic Substrate

1000 grams of substrate (Metaver, a meta-kaolin based waste silica product from the glass making industry with a bulk density of 0.57 g/cm³ and a mean particle size of 20-125 μm) was added to a Glatt GPCG 1.1, stainless steel fluidized bed. The fluidized bed was fitted in top spray mode and had a nominal capacity of one kilogram. The substrate was fluidized at 31.5° C. for thirty minutes, at an air flow of 75 to 80 m³/hour, prior to the outset of spraying to acclimatize the substrate to the humidity conditions in the fluidized bed. Particle size fractions outside the 20 to 125 μm range also functioned as acceptable substrates, although not necessarily with equivalent results.

During the experiment, the pressure of the bed rose steadily, as more of the polymeric liquid (AlpineFloc™ BHMW, a cationic polyacrylamide with 80 percent cationicity, by mass, due to the presence of a quaternary ammonium comonomer and a bulk density of 1.03 g/cm³) was sprayed onto the substrate. AlpineFloc™ BHMW was selected as the flocculant since it has a higher cationic charge than is typically possible to convert into a powder and has the highest know Weisenberg effect of any flocculant available, presenting a severe case in terms of conversion to a powder. Specifically, the pressure increased from 600 Pa at the outset to 1805 Pa, three hours and twenty-nine minutes after the process began (i.e., when spraying and fluidization were stopped). Overall, an off-white, light-brown, powder with a particle size of 0.2 to 0.8 mm was obtained. The particle size could be reduced with continued fluidization, at the same or slightly higher temperatures, after the cessation of the spraying. The off-brown powder had a density of 0.38 g/cm³ in its free flowing form, though the density could be increased via compacting. A total of 200 percent of the substrate, relative to the initial mass of the substrate, was sprayed, with a maximum spraying rate obtained initially at over 107 percent per hour. The temperature remained within 30 to 32° C. during the entire spraying process. This indicates that, for this substrate-polymeric liquid pair, high spraying rates and total polymeric liquid loading were possible and that the present experiment did not exceed the limits of evaporative cooling of the polymeric liquid, given that the temperature did not decrease, as it typically does during cooling processes.

Excellent fluidization was observed throughout the experiment, with the only delays due to the periodic de-plugging of the spraying nozzle using compressed air, though parallel experiments have attributed this clogging to insufficient pre-filtration of the inverse-emulsion. At the end of the experiment (three hours and twenty-nine minutes after the outset), the peristaltic spraying pump was stopped, following the cessation of air flow, and hence fluidization. The final product was removed from the bed by sliding aside the bottom plate filter. The final product dissolved in water within 15 minutes, compared to over forty-five minutes for a typical thermally dried flocculant and fifteen seconds for the AlpineFloc™ BHMW, as is typical for inverse-emulsion based flocculants. The final product had a viscosity in water (at 0.16 weight percent) of 1016±50 cp compared with 950±50 cp for the AlpineFloc™ BHMW when inverted, alone, at the same concentration. This suggests that any reduction in viscosity is minimal, and that the final product actually seems to have an increased viscosity. In comparison, prior art drying techniques, which use high temperatures (e.g., U.S. Patents to Davies et al.: U.S. Pat. Nos. 5,849,862, 5,869,562, 6,011,089, 6,039,881, 6,110,981, 6,296,903, 6,307,012 and 6,313,199), show a viscosity reduction of 7 percent, relative to the inverted water-in-oil system at the same concentration, is observed. The Glacier BHMW had a viscosity of 1016 cp after thirty minutes of dissolution, implying that it builds it viscosity more rapidly than typical powders that are dried.

### Example 2

### Free Flowing Dry Powder from a Flocculant Sprayed onto a Porous Inorganic Substrate of Low Density

100 grams of a low-density zeolite (Promaxon D, a synthetic hydrated calcium silicate) with a mean particle size of 35 to 85 μm and a bulk density of between 85 to 130 g/cm³ and a specific surface over 40 m²/gram, as measured by the BET method) was fluidized in a Glatt GPCG 1.1, stainless steel fluidized bed. The GPCG 1.1 had a nominal capacity one kilogram and was fitted in a top spray mode, identical to that described in Example 1, at a nominal temperature of 30° C. (set point, actual temperature was marginally lower (26 to 27° C., though recorded) for thirty minutes. During this time, and the subsequent spraying, the polymer mesh filters were shaken, alternatively, for fifteen seconds, with a pause of two seconds. After the zeolite was fluidized for thirty minutes, the atomization pressure, at 3.5 bars, was connected to the 0.8-mm nozzle and an inverse-emulsion of cationic polyacrylamide (AlpineFloc™ BHMW, see Example 1) was sprayed at a nominal pump setting of 15 mL per minute.

After thirty minutes, 140 percent of the mass of the polymeric liquid (AlpineFloc™ BHMW, which was described in Example 1) was added to the substrate (Promaxon D), corresponding to a loading rate of 560 percent per hour. During this time the product pressure rose from an initial 820 Pa to 1810 Pa, with the temperature decreasing slightly from 26.0° C. to 23.8° C. The air flow remained steady at 66±7 m³/hour through the entire experiment.

After thirty-two minutes the spraying pump was stopped for five minutes as the evaporative cooling, caused by the polymeric liquid dosage, was lowering the temperature of the bed. The lowering of the temperature was used to identify the thermodynamic spraying limit for a given substrate-polymeric liquid pair. With the spray rate reduced to approximately 7 mL per minute, the polymeric liquid was added for a further fifteen minutes after which (total time of thirty five minutes) 220 percent of polymeric liquid, relative to the initial mass of the substrate, had been added. During the finishing stage of the spraying, the spray pump was reduced further, to approximately 3 mL per minute, and after sixty-six minutes the process was stopped with a total of 330 percent loading (polymeric liquid relative to substrate initial mass).

At the end of the experiment (i.e., sixty six minutes after spray began), a free-flowing powder was removed from the bottom of the reactor. This was accomplished by sliding away the protective bottom plate and had a mass of 309 g, with a particle size of approximately 100 to 200 μm. The particle size can be reduced, at the end of the batch, by maintaining fluidization and increasing temperature. The powder had a density of 0.31 g/cm³. Given that, to the initial 100 g of substrate 330 g of polymeric liquid were added, this indicates a final activity level of approximately 44 percent. The difference in the 430 g of mass added and the 309 g (i.e., 131 g) of final mass corresponds to the evaporated water (132 g based on theoretical mass balances).

The free-flowing powder dissolved in deionized water to 99 percent of its ultimate viscosity (1180 cp) within fifteen minutes. Furthermore, this ultimate viscosity (1180 cp) is essentially equal, or even larger, to that obtained via the inversion of the polymeric liquid alone (AlpineFloc™ BHMW) in deionized water (950 cp), indicating, as was the case in Example 1, that the transformation from liquid to powder does not reduce viscosity in solution, as is the case with powders which are dried from liquids (e.g., Davies et al.: U.S. Pat. Nos. 5,849,862, 5,869,562, 6,011,089, 6,039,881, 6,110,981, 6,296,903, 6,307,012 and 6,313,199). As was the case in Example 1, the fluidized bed/spray cooled free flowing powder (Glacier BHMW) has more rapid dissolution in water than high-temperature dried products described in the prior art, including those by Davies et al, where the transformation of a liquid flocculant to a dry powder results in a loss in viscosity, in Davies' case by at least 7 percent.

### Example 3

### Fluidized Bed Spraying of Inverse-Emulsions in the Presence of Organic Substrates, at Higher Temperatures

The inverse-emulsion was fed directly to the fluidized bed and resulted in an excellent dry product which was re-dispersible in water at the concentrations which would be typically applied in Waste Water Treatment Plants (WWTPs). Seeding onto a porous substrate, or substrate, provided the best operating conditions and a fine, completely dry and substantially unagglomerated free flowing powder. The equipment and operating parameters for this test, carried out using porous sucrose as a substrate with the following characteristics: a diameter that is about 500 μm, and an internal porosity that is about 50 m²/g. This example is used to demonstrate that the substrate can be a completely inert carrier with no particular advantage in the potential application at hand (e.g., water treatment) and can also be based on natural, as well as organic, materials.

Testing Equipment

A Glatt GPCG-1 unit with a capacity of 1 Liter was employed using side spray nozzle. The various operating parameters are summarized in Table 1.

TABLE 1
Operating Parameters for the Fluidized Bed Drying
of Inverse-Emulsions using an Substrate

| | | | Range of | | |
|---|---|---|---|---|---|
| | | | Values During | | |
| Parameter | Set Point | | Experiment | | Comments |
| Inlet Air Temp. | 50° | C. | 49-50° | C. - | |
| Outlet Air Temp. | 40-45° | C. (ramp) | 40-43° | C. | The outlet air temperature was |
| | | | | | ramped up from a safe preliminary |
| | | | | | value to test the upper limits. |

| | | | | |
|---|---|---|---|---|
| Product Temp. | — | 40-45° | C. | — |

| | | | | |
|---|---|---|---|---|
| Atomizing Press. | 3.0 | bars | — | — |
| Pump Position | 15 | | — | Peristaltic pump. |
| Spray Rate | 8.5 | g/min | — | — |
| Air Flow | 3.5.5.1 | M3/h | | Varied throughout the |
| | | | | experiment in steps of 10 |
| | | | | minutes to test sensitivity. |
| Product Pressure | 0.2-0.5 | bars | — | Increased during the 65 minutes |
| | | | | of testing. |
| Filter Pressure | 0.8-1.4 | bars | — | Increased during the 65 minutes |
| | | | | of testing. |
| Position of Outlet | 35%/40% | | — | Changed from lower to higher |
| Air Flap | | | | setting after 30 minutes. |

### Example 4

### Fluidized Bed Spraying of Inverse-Emulsions in the Absence of a Substrate

### Comparative Example

An inverse-emulsion, which contained on the order of 50 percent of an isoparafinic mineral oil, and a dispersed phase containing a balance of water and high molar mass polymeric flocculant, based on acrylamide and cationic quaternary ammonium monomers, was prepared by techniques described elsewhere (U.S. Pat. No. 6,294,622) was sprayed in a fluidized bed. Spraying was carried out at the dilution acceptable for fluidized bed drying that is at a viscosity below 2000 cp under conditions identical to those described in Table 1. Spraying resulted in a semi-dry, agglomerated gum, with particle sizes of 5 to 10 mm, which remained quite sticky after the bed was emptied. Some discrete particles were observed with extensive agglomeration often into particles with sizes up to 1 cm, rendering the resuspendability of the product in water poor. Furthermore, the residual oil, which contributed to the gumminess, coated the internal walls of the fluidized bed dryer, resulting in extensive coagulum formation in the dryer. This counter example, therefore, illustrates the difficulties in applying fluidized bed drying to inverse-emulsions and their lack of good dissolution in water. Additionally, the residual oil level would discourage their applicability in a variety of applications where residual liquids must be held, often to levels below 1000 ppm. The results obtained in Example 4 were generally observed, irregardless of the oil content of the inverse-emulsion, when varied from 20 to 80 percent of the total mass of the inverse-emulsion. This counter example, therefore, demonstrates that the process of spray cooling is ineffective without a substrate and the lack of a substrate cannot be overcome with fluidization at higher temperatures because the pores and surface of the substrate acts as a nucleating agent for the evaporative cooling.

### Example 5

### Flocculation with the Sprayed Powder

The powder produced in Example 3 had a diameter of approximately 1-mm (1000 micrometers), with no coagulum or adhesion to the internal walls of the fluidized bed. It was rapidly redissolved in normal tap water, by dosing the polymer into the vortex of a 500-mL beaker containing 200 mL of water, which is a typical dissolution procedure for powdered flocculants. The flocculent, which is based on an inverse-emulsion, has very similar performance characteristics as the parent inverse-emulsion when utilized on a variety of sludges. These include dewatering times, turbidity, dry material of the resulting sludge and dosage profiles. Table 2 summarizes the comparison of a powdered flocculant prepared using the method described in Example 1, compared to its parent inverse-emulsion. In the experiments in Table 2, a digested sludge was obtained from the municipality of SIGE (Roche, Vaud, Switzerland) with an initial concentration of 3.36 g/L.

TABLE 2
Comparison of Flocculation using a Digested Sludge, of a Fluidized Bed Sprayed
Powdered Flocculant with the Inverse-emulsion from which it was Derived

| | | | | Dewatering | De-Hydration | |
|---|---|---|---|---|---|---|
| | | | | Kinetics: | Extent: | |
| | | | | Volume of | Volume | Dry |
| | Flocculant | Floc | | Filtrate | of Filtrate | Material |
| | Dosage | Size | Filtrate | After 10 s | after 10 s | (%) and |
| Flocculant | (ppm) | (mm) | Turbidity | (mL)* | (mL)* | Comments |
| Glacier | 100 | 1 | — | — | — | — |
| BHMW** | 200 | 1-3 | — | — | — | — |
| | 300 | 1-5 | — | — | — | — |
| | 350 | 1-7 | — | — | — | — |
| | 400 | 1-10 | — | — | — | — |
| | 450 | 2-15 | — | — | — | — |
| | 500 | 1-20 | VeryClear/ | 70 | 110 | — |
| | | | Yellow | | | |
| | 550 | 4-25 | VeryClear/ | 105 | 120 | 10.89 |
| | | | Yellow | | | |
| | 600 | 5-12 | VeryClear/ | 105 | 123 | 11.80 |
| | | | Yellow | | | |
| AlpineFloc ™ | 100 | — | — | — | — | — |
| BHWM | 200 | <1 | — | — | — | — |
| | 300 | 1-4 | — | — | — | — |
| | 350 | 1-5 | Clear/Gray | 20 | 35 | — |
| | 400 | 2-10 | Clear/ | 40 | 90 | — |
| | | | Yellow | | | |
| | 450 | 2-15 | Clear/ | 85 | 100 | 11.21 |
| | | | Yellow | | | |
| | 500 | 3-15 | VeryClear/ | 25 | 95 | Overdose |
| | | | Light | | | |
| | | | Yellow | | | |
| *Two hundred mL of sludge was mixed with varying amounts (column two) of a stock flocculant solution, at 0.4 wt %, in a one-liter beaker and agitated in a centrifugal fashion at 120 RPM | | | | | | |
| # for ten seconds. Following this time, the extremes of the floc size distribution were noted (column three) as well as the quality of the filtrate (column 4). The flocculated sludge was | | | | | | |
| # then placed over a metal mesh with a pore size of 0.5 μm and the volume drained after ten and sixty seconds was noted. Since tile sample had a volume of two hundred mL, each twenty mL | | | | | | |
| # drained corresponded to a ten percent dehydration. | | | | | | |

**The Glacier BHMW product, in Table 1, was dissolved at 0.4 g/L for twenty-eight minutes. The AlpineFloc ™ BHMW was dissolved at the same concentration for twenty-eight minutes.

Table 2 demonstrates that the AlpineFloc™ BHMW, inverse-emulsion, transformed into a free-flowing dry powder (Glacier BHMW) gives equivalent or larger floc sizes and equally good filtrate turbidity (i.e., clear, without turbidity, with a slight yellow residual from the sludge itself which is not removed in filtration). In more quantitative experiments, the Glacier, prepared in Example 1, powder form provides more rapid dewatering kinetics and more extensive dehydration than the flocculant (AlpineFloc™ BHMW) from which it was derived, at the same active material level. Indeed, Glacier BHMW eliminated 105 of 200 mL, or 52.5 percent, of water in 10 seconds, and 123 of 200 mL, or 61.5 percent in 60 seconds. In comparison, under the best conditions AlpineFloc™ BHMW only 85 and 100 mL, in ten and sixty seconds, corresponding to 42.5 and 50 percent dehydration. Furthermore, the Glacier BMHW provided a dry material level of between 10.89 and 11.80 percent under its best conditions, based on gravity filtration without any supplemental forces to improve dewatering, while AlpineFloc™ BHMW gave a dry material of 11.21 percent. Therefore, the two flocculants gave essentially equivalent solids levels, something that is not always the case for powders, since they have lower solution viscosities than the emulsions from which they are derived, when dried. It must be, further, noted that the Glacier BHMW was dissolved for only twenty eight minutes, which is quite a low time for a powder, which, when dried, as would be known to someone skilled in the art, requires, typically, forty-five to sixty minutes for dissolution.

Table 3 demonstrates that at a dissolution time of one minute, the Glacier BHMW (prepared in Example 1) provides good flocculation, though at a higher dosage than if dissolved for twenty-eight minutes, as was shown in Table 2. This demonstrates, however, that the Glacier free flowing powder dissolved rapidly, which is similar to a liquid inverse-emulsions, building its viscosity in a matter of minutes. Thus, polymeric powders that are prepared in the fluidized bed with spraying and evaporative cooling produce free flowing powders that advantageously dissolve like liquids. This is an important advantage over powders existing in the art, which require on the order of one hour to dissolve due to the hydration time needed.

TABLE 3
Summary of Flocculation Testing using a Digested Sludge of
a Fluidized Bed Sprayed Powdered Flocculant (Glacier BHMW)

| | | | | | De-Hydration | |
|---|---|---|---|---|---|---|
| | | | | | Extent: Volume | Dry |
| | Flocculant | Floc | | Dewatering Kinetics: | of Filtrate | Material |
| | Dosage | Size | Filtrate | Volume of Filtrate | after 10 s | (%) and |
| Flocculant | (ppm) | (mm) | Turbidity | After 10 s (in mL)* | (in mL)* | Comments |
| Glacier | 100 | 1 | — | — | — | — |
| BHMW** | 200 | 1 | — | — | — | — |
| | 300 | 1-4 | — | — | — | — |
| | 350 | 1-6 | — | — | — | — |
| | 400 | 1-8 | — | — | — | — |
| | 450 | 1-8 | — | — | — | — |
| | 500 | 1-8 | — | — | — | — |
| | 550 | 2-12 | — | — | — | — |
| | 600 | 2-10 | — | — | — | |
| | 650 | 2-10 | — | — | — | |
| | 700 | 1-15 | Clear | 85 | 125 | |
| | | | Yellow/ | | | |
| | | | Hazy | | | |

*The Glacier BHMW product, in Table 3, was dissolved at 0.4 g/L for one minute.

Many modifications and other embodiments of the invention set forth herein will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A polymeric powder that is formed of coated particles, wherein each particle comprises:
a substrate; and
a water-soluble polymer coated on the substrate, wherein each particle is coated with a polymer solid content that exceeds 20 weight percent based on the weight of the particle.

2. The polymeric powder according to claim 1, wherein the polymer is derived from one or more polymerizable ethylenically unsaturated monomers.

3. The polymeric powder according to claim 2, wherein the one or more polymerizable ethylenically unsaturated monomers are selected from the group consisting of acrylamide, methacrylamide, N-vinyl methyl acetamide, N-vinyl methyl formamide, dialkylaminoalkylmethacrylamide, sulphomethylated acrylamide, vinyl acetate, vinyl pyrrolidone, methacrylic esters, styrene, acrylonitrile, methacrylic acid, itaconic acid, acrylamido methyl propane sulphonic acid, allylsulphonate, sodium vinyl sulphonate, sodium acrylate, diallyldimethylammonium chloride, methacrylamidopropyl trimethylammonium chloride, dialkylaminoalkyl methacrylate, dialkylaminoalkyl acrylate, dialkylaminoalkyl acrylate methyl chloride, quaternary salts thereof, acid salts thereof, and mixtures thereof.

4. A polymeric powder according to claim 1, wherein the polymer is a polyacrylamide, polyamine, polyDADMACS, polyquaternaryamines, or copolymer or derivatives thereof.

5. A polymeric powder according to claim 1, wherein the polymer is a polyelectrolyte.

6. A polymeric powder according to claim 5, wherein the polymer is highly charged and comprised of 80 weight percent or more cationic monomers.

7. A polymeric powder according to claim 1, wherein each particle contains from about 30 to 47 percent polymer based on the weight of the particle.

8. A polymeric powder according to claim 1, wherein the powder is substantially unagglomerated.

9. A polymeric powder according to claim 1, wherein the substrate is porous.

10. A polymeric powder according to claim 9, wherein the substrate has an internal surface area from about 10 to 1000 m²/g.

11. A polymeric powder according to claim 1, wherein the substrate is a polysaccharide, sugar, glucose, malto, maltodextrose, manitol, kaolin, zeolite, calc, ferric chloride, ferric sulfate, aluminium sulphate, or derivatives or mixtures thereof.

12. A polymeric powder according to claim 1, wherein the substrate is zeolite and the polymer is polyacrylamide.

13. A polymeric powder according to claim 1, further including a binding agent for binding the polymer to the substrate.

14. A dry free-flowing polymeric powder that is comprised of porous substrate particulates that are coated with a water-soluble polymeric material, the porous substrate having an internal surface area from about 1 to 1000 m²/g, and wherein the amount of polymeric material coated on the substrate is from about 15 to 57 weight percent based on the weight of the particle.

15. A polymeric powder according to claim 14, wherein the porous substrate has an internal surface area that is from about 10 to 100 m²/g.

16. A polymeric powder according to claim 14, wherein the polymeric material is a polyelectrolyte that is cationic or anionic.

17. A polymeric powder according to claim 14, wherein the polymeric material has an average molecular weight from about 1,000 to 30 million Daltons.

18. A polymeric powder according to claim 14, wherein the amount of polymeric material coated on the substrate is from about 30 to 47 weight percent based on the weight of the particle.

19. A polymeric powder according to claim 14, wherein the substrate is kaolin, zeolite, calc, ferric chloride, ferric sulfate, aluminium sulphate, or mixtures thereof.

20. A polymeric powder according to claim 14, wherein the powder has a diameter from about 1 to 500 μm.

21. A polymeric powder according to claim 14, wherein the polymeric material is readily dissolvable in water and has a viscosity that is from about 966 to 1180 cp.

22. A polymeric powder according to claim 21, wherein the polymeric material has a viscosity that is from about 966 to 1066 cp.

23. A method of preparing a polymeric flocculant powder comprising:
a) providing a bed of porous substrate particles;
b) fluidizing the bed of particles with a stream of gas;
c) spraying a polymeric liquid into the fluidized bed of substrate particles, the polymeric liquid having a water-soluble polymer, oil phase, and an aqueous phase, whereby the aqueous phase is removed by evaporative cooling and the oil phase is substantially absorbed by the porous substrate and the polymer is coated onto the substrate to form a powder.

24. The method according to claim 23, wherein the polymer is derived from one or more polymerizable ethylenically unsaturated monomers.

25. The method according to claim 24, wherein the one or more polymerizable ethylenically unsaturated monomers are selected from the group consisting of acrylamide, methacrylamide, N-vinyl methyl acetamide, N-vinyl methyl formamide, dialkylaminoalkylmethacrylamide, sulphomethylated acrylamide, vinyl acetate, vinyl pyrrolidone, methacrylic esters, styrene, acrylonitrile, methacrylic acid, itaconic acid, acrylamido methyl propane sulphonic acid, allylsulphonate, sodium vinyl sulphonate, sodium acrylate, diallyldimethylammonium chloride, methacrylamidopropyl trimethylammonium chloride, dialkylaminoalkyl methacrylate, dialkylaminoalkyl acrylate, dialkylaminoalkyl acrylate methyl chloride, quaternary salts thereof, acid salts thereof, and mixtures thereof.

26. The method according to claim 24, wherein the polymer comprises at least one non-ionic monomer and at least one cationic monomer.

27. The method according to claim 26, wherein the non-ionic monomer is selected from the group consisting of acrylamide, methacrylamide, N-vinyl methyl acetamide, N-vinyl methyl formamide, vinyl acetate, vinyl pyrrolidone, methyl methacrylate, styrene, acrylonitrile, and mixtures thereof.

28. The method according to claim 27, wherein the non-ionic monomer is a monomer selected from the group consisting of acrylamide, methacrylamide, N-vinyl methyl acetamide, N-vinyl methyl formamide, dialkylaminoalkylmethacrylamide, sulphomethylated acrylamide, and mixtures thereof.

29. The method according to claim 28, wherein the cationic monomer is derived from one or more monomers selected from the group consisting of dialkylaminoalkylacrylates, dialkylaminoalkylmethacrylates, dialkylaminoalkylacrylamides, dialkylaminoalkylmethacrylamides, quaternary salts thereof, acid salts thereof, and mixtures thereof.

30. The method according to claim 29, wherein the non-ionic monomer is acrylamide and said cationic monomer is selected from the group consisting of dialkylaminoalkylmethacrylate quaternary salt, dialkylaminoalkylacrylate quaternary salt, and mixtures thereof, said cationic monomer comprising at least 30 weight percent of the total monomer composition.

31. The method according to claim 24, wherein the polymer comprises at least one non-ionic monomer and at least one anionic monomer.

32. The method according to claim 31, wherein the non-ionic monomer is selected from the group consisting of acrylamide, methacrylamide, N-vinyl methyl acetamide, N-vinyl methyl formamide, vinyl acetate, vinyl pyrrolidone, methyl methacrylate, styrene, acrylonitrile, and mixtures thereof.

33. The method according to claim 32, wherein the non-ionic monomer is selected from the group consisting of acrylamide, methacrylamide, N-vinyl methyl acetamide, N-vinyl methyl formamide, dialkylaminoalkylmethacrylamide, sulphomethylated acrylamide, and mixtures thereof.

34. The method according to claim 31, wherein the anionic monomer is selected from the group consisting of acrylic acid, methacrylic acid, sodium acrylate, ammonium acrylate, sodium methacrylate, ammonium methacrylate, sodium itaconate, 2-acrylamide 2-methyl propane sulphonate, sulphopropylacrylate, sulphopropylmethacrylate, and mixtures thereof.

35. The method polymer according to claim 34, wherein the non-ionic monomer is acrylamide and said anionic monomer comprises a mixture of methacrylic acid and acrylic acid.

36. The method according to claim 23, wherein the polymer is a polyacrylamide, polyamine, polyDADMACS , polyquatemaryamines, or copolymer or derivatives thereof.

37. The method according to claim 23, wherein the polymer is a cationic polyacrylamide having 80 percent cationicity by mass.

38. The method according to claim 23, wherein the substrate is a polysaccharide, sugar, glucose, sucrose, malto, maltodextrose, manitol, kaolin, zeolite, calc, ferric chloride, ferric sulfate, aluminium sulphate, or derivatives or mixtures thereof.

39. The method according to claim 23, wherein the substrate has an internal surface area from about 1 to 1000 m²/g.

40. The method according to claim 23, wherein the temperature of the fluidized bed is from about 20° C. to 50° C.

41. The method according to claim 23, wherein the temperature of the fluidized bed is from about 20° C. to 35° C.

42. The method according to claim 23, wherein the gas flow within the fluidized bed was from about 75 to 80 m³/hour.

43. The method according to claim 23, wherein the polymeric liquid has a viscosity that is from about 0.01 to 10,000 cp.

44. The method according to claim 23, wherein the polymeric liquid has a viscosity that is from about 10 to 1,000 cp.

45. The method according to claim 23, wherein the polymeric liquid is an inverse macroemulsion, inverse microemulsions, inverse suspensions, emulsion, dispersion, aqueous solution, or solution or dispersion that is in volatile polar liquid.

46. The method according to claim 23, wherein the polymeric powder dissolves quickly in water and has a viscosity that is approximately the same or greater than the viscosity of the polymeric liquid.

47. The method according to claim 23, wherein the powder has particle sizes from about 100 to 200 μm.

48. The method according to claim 23, wherein the amount of polymer coated on the substrate is from about 100 to 1000 percent of the initial mass of the substrate.

49. A process for flocculating an aqueous suspension of suspended solids comprising:
adding to the suspension a flocculating amount of a polymeric flocculant powder to form thereby an aqueous medium containing flocculated suspended solids, the flocculant powder being prepared by spraying a polymer-containing liquid into a fluidized bed of porous substrate particles, the polymeric liquid having a water-soluble polymer, oil phase, and an aqueous phase therein, whereby the aqueous phase is removed by evaporative cooling, the oil phase is substantially absorbed by the porous substrate and the polymer is coated onto the substrate to form the flocculant powder, the flocculant powder having in excess of 20 percent by weight polymeric material based on the weight of the powder.

50. The process according to claim 49, in which the aqueous medium is dewatered.

51. The process according to claim 50, wherein the aqueous medium is dewatered using a centrifuge, piston press, belt press dewatering, or precipitation.

52. The process according to claim 49, wherein the polymer has an intrinsic viscosity from about 966 to 1180 cp.

53. The process according to claim 49, wherein the porous substrate has an internal surface area from about 1 to 100 m²/g.

54. The process according to claim 49, the polymer is a polyacrylamide, polyamine, polyDADMACS , polyquaternaryamines, or copolymer or derivatives thereof.

55. The process according to claim 49, wherein the polymer is a cationic polyacrylamide having 80 percent cationicity by mass.
